(19) United States
(12) Patent Application Publication
(10) Pub. No.: US 2023/0170598 A1
(43) Pub. Date: Jun. 1, 2023

(54) PERIPHERAL RF CHOKE AND Z DIRECTION HEAT PIPE

(71) Applicant: Kymeta Corporation, Redmond, WA (US)

(72) Inventors: Ryan Stevenson, Seattle, WA (US); Arvind Krishna, Redmond, WA (US)

(21) Appl. No.: 17/891,944

(22) Filed: Aug. 19, 2022

Related U.S. Application Data
(60) Provisional application No. 63/236,573, filed on Aug. 24, 2021.

(51) Int. Cl. H01Q 1/02; H01Q 1/42; H01Q 9/04

(52) U.S. Cl. CPC H01Q 1/02; H01Q 1/421; H01Q 9/0407

(57) ABSTRACT

An antenna apparatus having a peripheral radio-frequency (RF) choke with directional heat transfer is described. In some embodiments, an antenna apparatus comprises: an upper enclosure portion; a lower enclosure portion coupled to the upper enclosure portion to form an inner area; an antenna aperture having a plurality of antenna elements, the plurality of antenna elements to radiate radio-frequency (RF) energy and the antenna aperture to generate heat when in operation; and an RF choke gasket between, and forming a thermal communication, with the upper and lower enclosures to operate as an RF absorber to absorb RF energy and to directionally transfer the heat toward the upper enclosure.

### RELATED APPLICATION

The present application is a non-provisional application of and claims the benefit of U.S. Provisional Patent Application No. 63/236,573, filed Aug. 24, 2021, and entitled “Peripheral RF Choke and Z Direction Heat Pipe”, which is incorporated by reference in its entirety.

### FIELD OF THE INVENTION

Embodiments disclosed herein are related to wireless communication; more particularly, embodiments disclosed herein are related to antennas for wireless communication that include a radio-frequency (RF) choke that transfers heat directionally.

### BACKGROUND

Metasurface antennas have recently emerged as a new technology for generating steered, directive beams from a lightweight, low-cost, and planar physical platform. Such metasurface antennas have been recently used in a number of applications, such as, for example, satellite communication.

Metasurface antennas may comprise metamaterial antenna elements that can selectively couple energy from a feed wave to produce beams that may be controlled for use in communication. These antennas are capable of achieving comparable performance to phased array antennas from an inexpensive and easy-to-manufacture hardware platform.

Some metasurface antenna designs include a radial waveguide that feeds a metasurface antenna aperture having radio-frequency (RF) radiating antenna elements. In at least one prior art design, an RF absorber ring is placed around the periphery of the radial waveguide to absorb any energy that is not coupled to the metasurface antenna aperture. This ring is comprised of a foam material that is a poor thermal conductor.

Furthermore, in some antenna designs, there is no capability to heat the radome. This lack of heating allows snow and ice to accumulate on the radome surface, thereby attenuating RF signals. To provide heating to a radome, prior art designs include leveraging heat pipes with traditional conductors (e.g., copper), resistive heating elements or thermo-electric elements. In at least one phased array antenna design, heat generated by electronic components of the phased array antenna is directed towards a radome for de-icing purposes using traditional thermal conductors (e.g., metals) and thermal interface materials (TIM) that are well-known to those skilled in the art, as well as radome spacer materials that have very low RF losses, which is not appropriate and/or useful for other antenna designs. Other the materials that have been used include various types of foams or plastics that have low thermal conductivity.

### SUMMARY

An antenna apparatus having a peripheral radio-frequency (RF) choke with directional heat transfer is described. In some embodiments, an antenna apparatus comprises: an upper enclosure portion; a lower enclosure portion coupled to the upper enclosure portion to form an inner area; an antenna aperture having a plurality of antenna elements, the plurality of antenna elements to radiate radio-frequency (RF) energy and the antenna aperture to generate heat when in operation; and an RF choke gasket between, and forming a thermal communication, with the upper and lower enclosures to operate as an RF absorber to absorb RF energy and to directionally transfer the heat toward the upper enclosure.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an exploded view of some embodiments of a flat-panel antenna.

FIG. 2 illustrates an example of a communication system that includes one or more antennas described herein.

FIG. 3A illustrates some embodiments of a satellite terminal with an RF choke gasket with directionally oriented thermal conductivity.

FIGS. 3B and 3C illustrate some embodiments of thin heating strips.

FIG. 4 shows an antenna aperture with an RF choke gasket being wrapped around it prior to being enclosed by a radome and a backshell.

FIG. 5 is an underside view of radome with a plurality of mating parts in a radome collar that can receive protrusions.

FIG. 6 illustrates an example of a protrusion that may be used for a snap fit joint.

### DETAILED DESCRIPTION

In the following description, numerous details are set forth to provide a more thorough explanation of the disclosed embodiments. It will be apparent, however, to one skilled in the art, that the embodiments may be practiced without these specific details. In other instances, well-known structures and devices are shown in block diagram form, rather than in detail, in order to avoid obscuring the claimed embodiments.

Antenna apparatuses and methods for using the same are disclosed. In some embodiments, the antenna apparatuses disclosed herein include a device that accomplishes the multiple objectives of a) operating as a radio-frequency (RF) choke around the periphery of a satellite communication antenna, and b) directionally transferring heat. In other words, the RF choke has directionally oriented thermal conductivity. In some embodiments, the directional transfer of heat resembles the operation of a heat pipe. In some embodiments, the transfer of heat is in a Z direction (in an X, Y, Z coordinate system) exclusively or near exclusively (e.g., 90% of heat transferred in the Z direction, etc.). In some embodiments, the transfer of heat in the Z direction is toward a radome (or other top cover of an antenna aperture) to enable cold weather de-icing of a radome using a single continuous component. In some embodiments, the device exploits directional properties of the material of an RF choke gasket to achieve these effects, eliminating the need to use separate parts for an RF choke and a thermal heater. In some other embodiments, the device also performs a gasket sealing function to the antenna, enabling a tortuous path to prevent ingress of moisture into the antenna.

The following disclosure discusses examples of antenna apparatus embodiments followed by details of RF chokes within the antennas that may be used to transfer heat to different locations in the antenna apparatus.

### Examples of Antenna Embodiments

The techniques described herein may be used with a variety of flat panel satellite antennas. Embodiments of such flat panel antennas are disclosed herein. In some embodiments, the flat panel satellite antennas are part of a satellite terminal. The flat panel antennas include one or more arrays of antenna elements on an antenna aperture.

In some embodiments, the antenna aperture is a metasurface antenna aperture, such as, for example, the antenna apertures described below. In some embodiments, the antenna elements comprise radio-frequency (RF) radiating antenna elements. In some embodiments, the antenna elements include tunable devices to tune the antenna elements. Examples of such tunable devices include diodes and varactors such as, for example, described in U.S. Patent Application Publication No. 20210050671, entitled “Metasurface Antennas Manufactured with Mass Transfer Technologies,” published Feb. 18, 2021. In some other embodiments, the antenna elements comprise liquid crystal (LC)-based antenna elements, such as, for example, those disclosed in U.S. Pat. No. 9,887,456, entitled “Dynamic Polarization and Coupling Control from a Steerable Cylindrically Fed Holographic Antenna”, issued Feb. 6, 2018, or other RF radiating antenna elements. It should be appreciated that other tunable devices such as, for example, but not limited to, tunable capacitors, tunable capacitance dies, packaged dies, micro-electromechanical systems (MEMS) devices, or other tunable capacitance devices, could be placed into an antenna aperture or elsewhere in variations on the embodiments described herein.

In some embodiments, the antenna aperture having the one or more arrays of antenna elements is comprised of multiple segments that are coupled together. In some embodiments, when coupled together, the combination of the segments form groups of antenna elements (e.g., closed concentric rings of antenna elements concentric with respect to the antenna feed, etc.). For more information on antenna segments, see U.S. Pat. No. 9,887,455, entitled “Aperture Segmentation of a Cylindrical Feed Antenna”, issued Feb. 6, 2018.

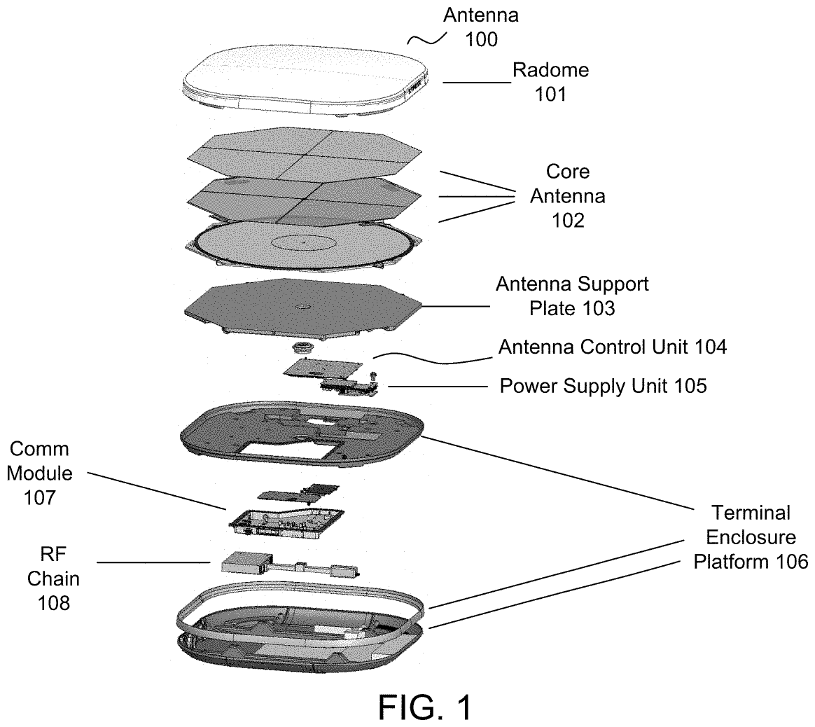

FIG. 1 illustrates an exploded view of some embodiments of a flat-panel antenna. Referring to FIG. 1, antenna 100 comprises a radome 101, a core antenna 102, antenna support plate 103, antenna control unit (ACU) 104, a power supply unit 105, terminal enclosure platform 106, comm (communication) module 107, and RF chain 108.

Radome 101 is the top portion of an enclosure that encloses core antenna 102. In some embodiments, radome 101 is weatherproof and is constructed of material transparent to radio waves to enable beams generated by core antenna 102 to extend to the exterior of radome 101.

In some embodiments, core antenna 102 comprises an aperture having RF radiating antenna elements. These antenna elements act as radiators (or slot radiators). In some embodiments, the antenna elements comprise scattering metamaterial antenna elements. In some embodiments, the antenna elements comprise both Receive (Rx) and Transmit (Tx) irises, or slots, that are interleaved and distributed on the whole surface of the antenna aperture of core antenna 102. Such Rx and Tx irises may be in groups of two or more sets where each set is for a separately and simultaneously controlled band. Examples of such antenna elements with irises are described in U.S. Pat. No. 10,892,553, entitled “Broad Tunable Bandwidth Radial Line Slot Antenna”, issued Jan. 12, 2021.

In some embodiments, the antenna elements comprise irises (iris openings) and the aperture antenna is used to generate a main beam shaped by using excitation from a cylindrical feed wave for radiating the iris openings through tunable elements (e.g., diodes, varactors, patch, etc.). In some embodiments, the antenna elements can be excited to radiate a horizontally or vertically polarized electric field at desired scan angles.

In some embodiments, a tunable element (e.g., diode, varactor, patch etc.) is located over each iris slot. The amount of radiated power from each antenna element is controlled by applying a voltage to the tunable element using a controller in ACU 104. Traces in core antenna 102 to each tunable element are used to provide the voltage to the tunable element. The voltage tunes or detunes the capacitance and thus the resonance frequency of individual elements to effectuate beam forming. The voltage required is dependent on the tunable element in use. Using this property, in some embodiments, the tunable element (e.g., diode, varactor, LC, etc.) integrates an on/off switch for the transmission of energy from a feed wave to the antenna element. When switched on, an antenna element emits an electromagnetic wave like an electrically small dipole antenna. Note that the teachings herein are not limited to having unit cell that operates in a binary fashion with respect to energy transmission. For example, in some embodiments in which varactors are the tunable element, there are 32 tuning levels. As another example, in some embodiments in which LC is the tunable element, there are 16 tuning levels.

A voltage between the tunable element and the slot can be modulated to tune the antenna element (e.g., the tunable resonator/slot). Adjusting the voltage varies the capacitance of a slot (e.g., the tunable resonator/slot). Accordingly, the reactance of a slot (e.g., the tunable resonator/slot) can be varied by changing the capacitance. Resonant frequency of the slot also changes according to the equation

$$f = \frac{1}{2 π \sqrt{LC}}$$

where f is the resonant frequency of the slot and L and C are the inductance and capacitance of the slot, respectively. The resonant frequency of the slot affects the energy coupled from a feed wave propagating through the waveguide to the antenna elements.

In particular, the generation of a focused beam by the metamaterial array of antenna elements can be explained by the phenomenon of constructive and destructive interference, which is well known in the art. Individual electromagnetic waves sum up (constructive interference) if they have the same phase when they meet in free space to create a beam, and waves cancel each other (destructive interference) if they are in opposite phase when they meet in free space. If the slots in core antenna 102 are positioned so that each successive slot is positioned at a different distance from the excitation point of the feed wave, the scattered wave from that antenna element will have a different phase than the scattered wave of the previous slot. In some embodiments, if the slots are spaced one quarter of a wavelength apart, each slot will scatter a wave with a one fourth phase delay from the previous slot. In some embodiments, by controlling which antenna elements are turned on or off (i.e., by changing the pattern of which antenna elements are turned on and which antenna elements are turned off) or which of the multiple tuning levels is used, a different pattern of constructive and destructive interference can be produced, and the antenna can change the direction of its beam(s).

In some embodiments, core antenna 102 includes a coaxial feed that is used to provide a cylindrical wave feed via an input feed, such as, for example, described in U.S. Pat. No. 9,887,456, entitled “Dynamic Polarization and Coupling Control from a Steerable Cylindrically Fed Holographic Antenna”, issued Feb. 6, 2018 or in U.S. Patent Application Publication No. 20210050671, entitled “Metasurface Antennas Manufactured with Mass Transfer Technologies,” published Feb. 18, 2021. In some embodiments, the cylindrical wave feed feeds core antenna 102 from a central point with an excitation that spreads outward in a cylindrical manner from the feed point. In other words, the cylindrically fed wave is an outward travelling concentric feed wave. Even so, the shape of the cylindrical feed antenna around the cylindrical feed can be circular, square or any shape. In some other embodiments, a cylindrically fed antenna aperture creates an inward travelling feed wave. In such a case, the feed wave most naturally comes from a circular structure.

In some embodiments, the core antenna comprises multiple layers. These layers include the one or more substrate layers forming the RF radiating antenna elements. In some embodiments, these layers may also include impedance matching layers (e.g., a wide-angle impedance matching (WAIM) layer, etc.), one or more spacer layers and/or dielectric layers. Such layers are well-known in the art.

Antenna support plate 103 is coupled to core antenna 102 to provide support for core antenna 102. In some embodiments, antenna support plate 103 includes one or more waveguides and one or more antenna feeds to provide one or more feed waves to core antenna 102 for use by antenna elements of core antenna 102 to generate one or more beams.

ACU 104 is coupled to antenna support plate 103 and provides controls for antenna 100. In some embodiments, these controls include controls for drive electronics for antenna 100 and a matrix drive circuitry to control a switching array interspersed throughout the array of RF radiating antenna elements. In some embodiments, the matrix drive circuitry uses unique addresses to apply voltages onto the tunable elements of the antenna elements to drive each antenna element separately from the other antenna elements. In some embodiments, the drive electronics for ACU 104 comprise commercial off-the shelf LCD controls used in commercial television appliances that adjust the voltage for each antenna element.

More specifically, in some embodiments, ACU 104 supplies an array of voltage signals to the tunable devices of the antenna elements to create a modulation, or control, pattern. The control pattern causes the elements to be tuned to different states. In some embodiments, ACU 104 uses the control pattern to control which antenna elements are turned on or off (or which of the tuning levels is used) and at which phase and amplitude level at the frequency of operation. The elements are selectively detuned for frequency operation by voltage application. In some embodiments, multistate control is used in which various elements are turned on and off to varying levels, further approximating a sinusoidal control pattern, as opposed to a square wave (i.e., a sinusoid gray shade modulation pattern).

In some embodiments, ACU 104 also contains one or more processors executing the software to perform some of the control operations. ACU 104 may control one or more sensors (e.g., a GPS receiver, a three-axis compass, a 3-axis accelerometer, 3-axis gyro, 3-axis magnetometer, etc.) to provide location and orientation information to the processor(s). The location and orientation information may be provided to the processor(s) by other systems in the earth station and/or may not be part of the antenna system.

Antenna 100 also includes a comm (communication) module 107 and an RF chain 108. Comm module 107 includes one or more modems enabling antenna 100 to communicate with various satellites and/or cellular systems, in addition to a router that selects the appropriate network route based on metrics (e.g., quality of service (QoS) metrics, e.g., signal strength, latency, etc.). RF chain 108 converts analog RF signals to digital form. In some embodiments, RF chain 108 comprises electronic components that may include amplifiers, filters, mixers, attenuators, and detectors.

Antenna 100 also includes power supply unit 105 to provide power to various subsystems or parts of antenna 100.

Antenna 100 also includes terminal enclosure platform 106 that forms the enclosure for the bottom of antenna 100. In some embodiments, terminal enclosure platform 106 comprises multiple parts that are coupled to other parts of antenna 100, including radome 101, to enclose core antenna 102.

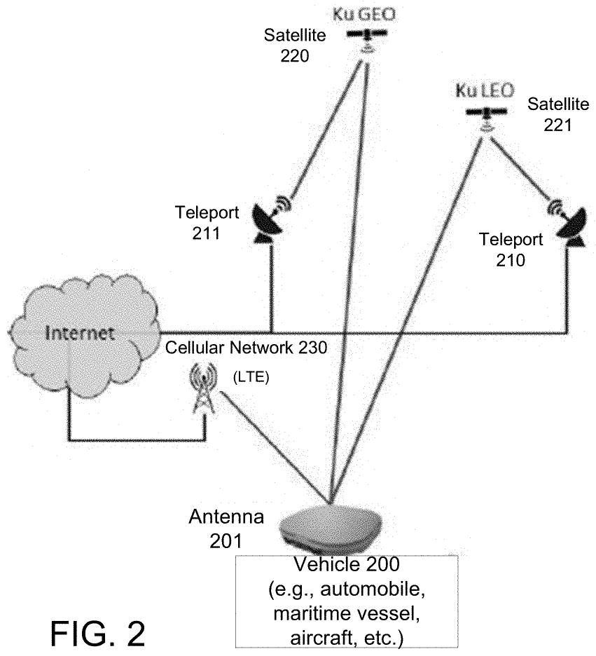

FIG. 2 illustrates an example of a communication system that includes one or more antennas described herein. Referring to FIG. 2, vehicle 200 includes an antenna 201. In some embodiments, antenna 201 comprises antenna 100 of FIG. 1.

In some embodiments, vehicle 200 may comprise any one of several vehicles, such as, for example, but not limited to, an automobile (e.g., car, truck, bus, etc.), a maritime vehicle (e.g., boat, ship, etc.), airplanes (e.g., passenger jets, military jets, small craft planes, etc.), etc. Antenna 201 may be used to communicate while vehicle 200 is either on-the-pause, or moving. Antenna 201 may be used to communicate to fixed locations as well, e.g., remote industrial sites (mining, oil, and gas) and/or remote renewable energy sites (solar farms, windfarms, etc.).

In some embodiments, antenna 201 is able to communicate with one or more communication infrastructures (e.g., satellite, cellular, networks (e.g., the Internet), etc.). For example, in some embodiments, antenna 201 is able to communication with satellites 220 (e.g., a GEO satellite) and 221 (e.g., a LEO satellite), cellular network 230 (e.g., an LTE, etc.), as well as network infrastructures (e.g., edge routers, Internet, etc.). For example, in some embodiments, antenna 201 comprises one or more satellite modems (e.g., a GEO modem, a LEO modem, etc.) to enable communication with various satellites such as satellite 220 (e.g., a GEO satellite) and satellite 221 (e.g., a LEO satellite) and one or more cellular modems to communicate with cellular network 230. For another example of an antenna communicating with one or more communication infrastructures, see U.S. patent Ser. No. 16/750,439, entitled “Multiple Aspects of Communication in a Diverse Communication Network”, and filed Jan. 23, 2020.

In some embodiments, to facilitate communication with various satellites, antenna 201 performs dynamic beam steering. In such a case, antenna 201 is able to dynamically change the direction of a beam that it generates to facilitate communication with different satellites. In some embodiments, antenna 201 includes multi-beam beam steering that allows antenna 201 to generate two or more beams at the same time, thereby enabling antenna 201 to communication with more than one satellite at the same time. Such functionality is often used when switching between satellites (e.g., performing a handover). For example, in some embodiments, antenna 201 generates and uses a first beam for communicating with satellite 220 and generates a second beam simultaneously to establish communication with satellite 221. After establishing communication with satellite 221, antenna 201 stops generating the first beam to end communication with satellite 220 while switching over to communicate with satellite 221 using the second beam. For more information on multi-beam communication, see U.S. Pat. No. 11,063,661, entitled “Beam Splitting Hand Off Systems Architecture”, issued Jul. 13, 2021.

In some embodiments, antenna 201 uses path diversity to enable a communication session that is occurring with one communication path (e.g., satellite, cellular, etc.) to continue during and after a handover with another communication path (e.g., a different satellite, a different cellular system, etc.). For example, if antenna 201 is in communication with satellite 220 and switches to satellite 221 by dynamically changing its beam direction, its session with satellite 220 is combined with the session occurring with satellite 221.

Thus, the antennas described herein may be part of a satellite terminal that enables ubiquitous communications and multiple different communication connections.

RF Choke with Directional Heat Transfer

Embodiments disclosed herein include an antenna apparatus with an RF choke that functions as an anisotropic, Z-directional thermal conductor at the periphery of an antenna. Having one device to provide multiple functionalities eliminates the need to have two separate, and potentially three separate, parts to accomplish the objectives of an RF choke, Z direction heating method, and a sealing gasket around the periphery of the antenna. This results in significant cost saving, part consolidation and assembly simplification, and an innovative use of composite materials with directionally oriented thermal conductivity to achieve RF and thermal objectives.

In some embodiments, heat from interior of the antenna is transferred in the Z-direction to perform Z-direction heating, which solves a problem of bringing heat to the radome in an antenna apparatus. This heating is done while also performing as an RF choke (e.g., an RF absorber ring).

In some embodiments, an antenna apparatus comprises an upper enclosure and a lower enclosure that are coupled together. In some embodiments, the upper enclosure comprises a radome and the lower enclosure comprises a backshell. In some embodiments, when coupled, the upper and lower enclosures form an inner area in which the core antenna resides. In some embodiments, the core antenna comprises an antenna aperture having antenna elements that radiate radio-frequency (RF) energy as described above. The antenna aperture also generates heat when in operation.

An RF choke gasket forms a seal between the upper and lower enclosures to operate as an RF absorber to absorb, or otherwise suppress, RF energy and to directionally transfer the heat toward the upper enclosure. To that end, in some embodiments, the RF choke gasket is in thermal contact with the upper and lower enclosures. In some embodiments, the upper enclosure (e.g., a radome), the lower enclosure (e.g., a backshell) and the core antenna (including the antenna aperture) are aligned in a Z direction of an X,Y,Z axis and the RF choke gasket is operable to directionally transfer heat in the Z direction toward the upper enclosure. In some embodiments, when the upper enclosure comprises a radome, the RF choke gasket serves to directionally transfer the heat towards the radome.

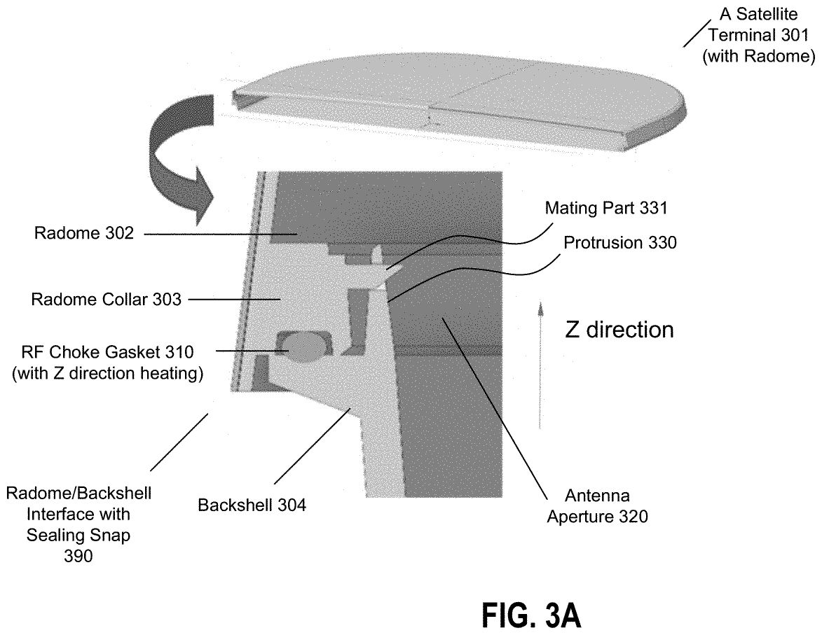

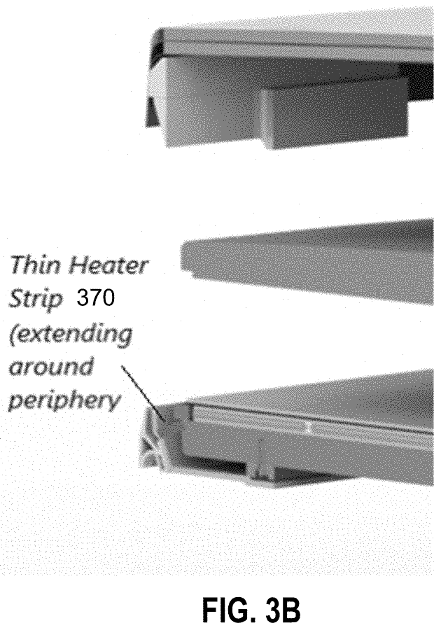

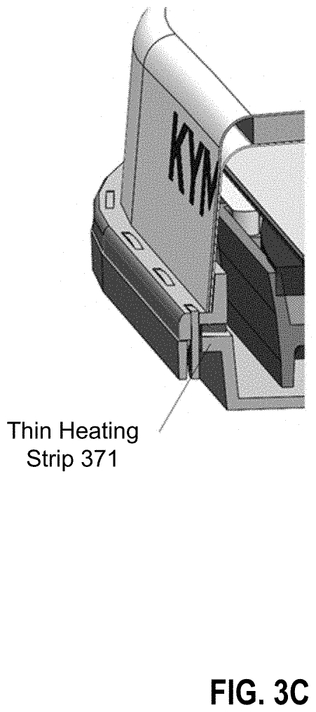

FIG. 3A illustrates some embodiments of a satellite terminal with an RF choke gasket with directionally oriented thermal conductivity. Referring to FIG. 3A, satellite terminal 301 includes a radome 302 having a radome collar 303 that is around the periphery of radome 302 as well as the periphery of the core antenna with its antenna aperture 320. Radome 302 is coupled to a backshell 304, which is beneath antenna aperture 320. In some embodiments, RF choke gasket 310 is pressed between radome collar 303 and backshell 304 to act as a seal between radome 302 and backshell 304. Thus, in this case, RF choke gasket 310 also acts as a gasket seal to provide ingress protection as well as a Z-axis thermal conductor and RF choke.

In some embodiments, RF choke gasket 310 comprises a composite material (e.g., a compound material having carbon fibers, etc.) with directional properties that enable RF choke gasket 310 to perform a primary function of being an RF choke around the periphery of antenna aperture 320 for a chosen bandwidth of frequencies of interest to satellite communication applications in certain frequency bands. In some embodiments, frequency bands include the Ku and Ka bands. However, the RF choke gasket may be designed to suppress other frequency bands, such as for example, but not limited to, X-band, Q band, and V band.

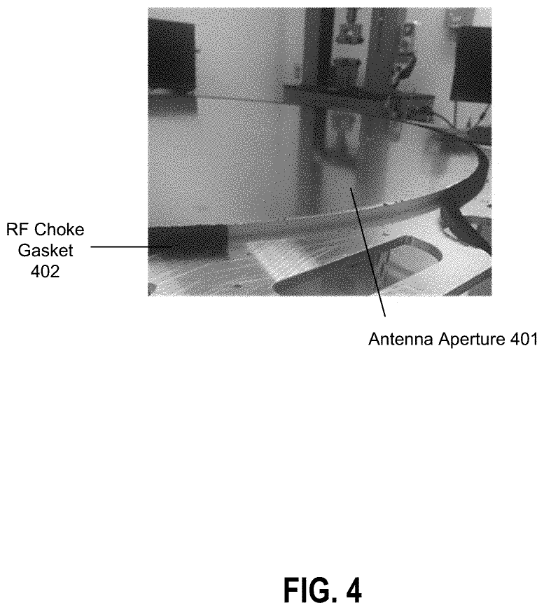

In some embodiments, antenna aperture 320 comprises a stack of layers with an outer edge at a side of the stack, and RF choke gasket 310 is located along the outer edge at a periphery of antenna aperture 320 to suppress RF energy in one or more frequency bands propagating at the outer edge of antenna aperture 320. In some embodiments, RF choke gasket 310 comprises a ring around the antenna aperture stack, or portion thereof. FIG. 4 shows an antenna aperture 401 with an RF choke gasket 402 being wrapped around it prior to being enclosed by a radome (an upper enclosure) and a backshell (a lower enclosure).

In addition, the directionally oriented thermal conductivity in the Z direction due to the material of RF choke gasket 310 can be combined with a thin heating element (e.g., thin heating strip 370 of FIG. 3B and thin heating strip 371 of FIG. 3C) at the base of a sealing snap 390 to enable a heat pipe effect that directs heat to radome 302 through radome collar 303 during cold conditions requiring de-icing or operational melting of snow to enable radome 302 to function. In some embodiments, radome 302 includes an RF transparent, thermal conductive coating that transfers heat received via the Z-direction from RF choke gasket 310 throughout the interior top surface of radome 302 (or portions covered by the coating).

In some embodiments, RF choke gasket 310 is an anisotropic material or composite material. In some embodiments, the composite material utilizing a combinations of continuous (long) and short carbon fibers (e.g., carbon fibers with fiber orientations). Examples of the carbon fiber based composite material are available from Boston Materials of Billerica, Mass. Such materials are traditionally intended for structural applications such as replacing steel, but lend themselves to the RF choke application described herein. Such composite materials range from hard and stiff constructions, using base materials such as thermosets, to softer rubbery constructions. Those materials that are rubbery or less stiff lend themselves to operation as a gasket. Manufacturing methods that enable selective positioning of fiber orientations to achieve a desired effect, such as Z directional conductivity, make these materials useful as an RF choke and a device to directionally transfer heat. In some other embodiments, RF choke gasket 310 comprises an Anisotropic Conductive Film (ACF). One such Anisotropic Conductive Film (ACF) is acrylic adhesive layer with beads that directionally transfer heat after the layer has been applied in which the beads provide z-axis conductivity while preventing lateral conductivity.

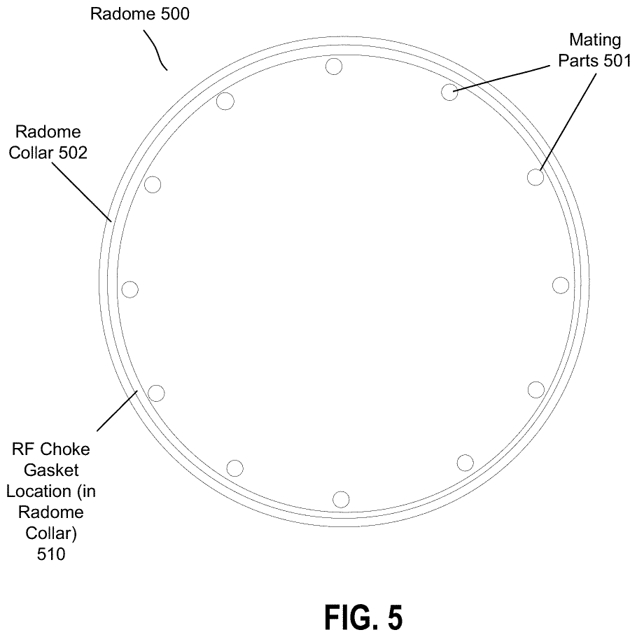

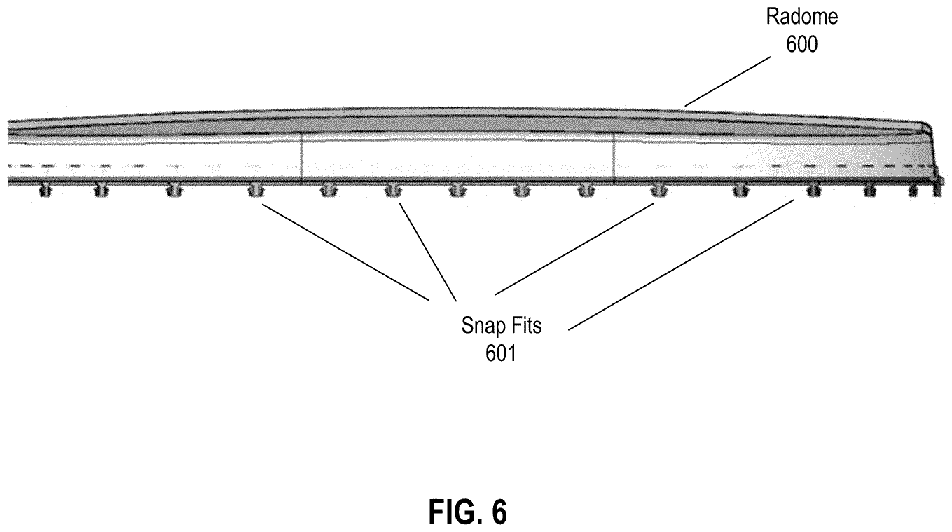

In some embodiments, radome 302 and backshell 304 are coupled to each other via sealing snap 390 around the antenna aperture. In some embodiments, radome 302 and backshell 304 are snapped together using snap fit joints. For example, protrusion 330 extending up from backshell 304 is inserted into mating part 331 of radome collar 303 and forms an interlocking connection. FIG. 5 is an underside view of radome 500 with a plurality of mating parts 501 (e.g., 20 mating parts, 30 mating parts, etc.) in radome collar 502 that can receive protrusions, such as, for example, but not limited to snap fits 601 (e.g., U-shaped features) of FIG. 6 to create a number of snap fit joints around the periphery of radome 600, and thus, the antenna. Note that any number of protrusions and mating parts may be used to form an interlocking connection.

In some embodiments, the antenna apparatus has a thin heater on the flat surface of the mating members, with RF choke gasket 310 placed on top. With RF choke gasket 310 in position, radome 302 and backshell 304 may be snap fit to secure the interface between them for the multiple purposes of RF choke, Z direction heating and sealing around the terminal periphery (as RF choke gasket 310 is compressed).

In some alternative embodiments, instead of using the RF choke gasket in the periphery around the outside of the antenna aperture, an RF choke that has a Z direction heating element may be used in an interior location to an antenna assembly.

In some other alternative embodiments, instead of employing a heater, the use of the RF choke gasket is limited to situations where RF choking of a set of frequencies is accomplished with a Z directional thermal conductivity benefit only (without heating).

In some other alternative embodiments, the RF choke gasket is configured to a shape of a heat sink, with the explicit purpose of conducting heat in one direction away from an electronic unit or component in the antenna (or other wireless component) that is both RF sensitive and highly heat dissipative. In some embodiments, such a heat sink includes fins that transfer heat in the Z direction.

In some other alternative embodiments, instead of employing a heater, a traditional flat heat pipe is used to convey heat from the interior of the satellite terminal to the peripheral Z direction RF gasket, which may be used as the unit warms up from a cold start. In this case, the waste heat is conducted to the periphery in a horizontal manner and then, utilizing the unique properties in the Z direction, this heat gets piped upward onto an edge of the radome (upper enclosure).

There are a number of example embodiments described herein.

Example 1 is an antenna apparatus comprising: an upper enclosure portion; a lower enclosure portion coupled to the upper enclosure portion to form an inner area; an antenna aperture having a plurality of antenna elements, the plurality of antenna elements to radiate radio-frequency (RF) energy and the antenna aperture to generate heat when in operation; and an RF choke gasket between, and forming a thermal communication, with the upper and lower enclosures to operate as an RF absorber to absorb RF energy and to directionally transfer the heat toward the upper enclosure.

Example 2 is the antenna apparatus of example 1 that may optionally include that the upper enclosure comprises a radome and the lower enclosure comprises a backshell, wherein the RF choke gasket to directionally transfer the heat towards the radome.

Example 3 is the antenna apparatus of example 2 that may optionally include that the upper enclosure, lower enclosure and the antenna aperture are aligned in a Z direction of an X,Y,Z axis and the RF choke gasket is operable to directionally transfer heat in the Z direction.

Example 4 is the antenna apparatus of example 1 that may optionally include that the RF choke gasket comprises an anisotropic material.

Example 5 is the antenna apparatus of example 1 that may optionally include that the RF choke gasket comprises a compound material having carbon fibers.

Example 6 is the antenna apparatus of example 1 that may optionally include that the antenna aperture includes an outer edge, and the RF choke gasket is located adjacent the outer edge and a periphery of the antenna aperture, and configured to suppress RF energy in one or more frequency bands.

Example 7 is the antenna apparatus of example 6 that may optionally include that the one or more frequency bands comprise at least one of the Ku, Ka, X, Q, and V bands.

Example 8 is the antenna apparatus of example 6 that may optionally include that the RF choke gasket comprises a ring around the antenna aperture.

Example 9 is the antenna apparatus of example 1 that may optionally include that the upper and lower enclosures include complementary snap features configured to couple the upper and lower enclosures.

Example 10 is the antenna apparatus of example 1 that may optionally include that the plurality of antenna elements comprise a plurality of metamaterial antenna elements, each metamaterial antenna element of the plurality of metamaterial antenna elements having a tunable element.

Example 11 is the antenna apparatus of example 10 that may optionally include that the tunable element comprises a varactor diode.

Example 12 is an antenna apparatus comprising: a radome; a lower enclosure portion coupled to the upper enclosure portion to form an inner area; an antenna aperture having a plurality of antenna elements, the plurality of antenna elements to radiate radio-frequency (RF) energy and the antenna aperture to generate heat when in operation, wherein the radome, lower enclosure and the antenna aperture are aligned in a Z direction of an X,Y,Z axis and the RF choke gasket is operable to transfer heat in the Z direction; and an RF choke gasket forming a seal between, and being in thermal communication with, the upper and lower enclosures to operate as an RF absorber and to transfer the heat in the Z direction toward the radome, wherein the RF choke is located adjacent an outer edge at a periphery of the antenna aperture to suppress RF energy in one or more frequency bands.

Example 13 is the antenna apparatus of example 12 that may optionally include that the RF choke gasket comprises an anisotropic material.

Example 14 is the antenna apparatus of example 12 that may optionally include that the RF choke gasket comprises a compound material having carbon fibers.

Example 15 is the antenna apparatus of example 12 that may optionally include that the one or more frequency bands comprise at least one of Ku, Ka, X, Q, and V bands.

Example 16 is the antenna apparatus of example 12 that may optionally include that the RF choke gasket comprises a ring around the antenna aperture.

Example 17 is the antenna apparatus of example 12 that may optionally include that the upper and lower enclosures include complementary snap features configured to couple the upper and lower enclosures.

Example 18 is an antenna apparatus comprising: an upper enclosure portion; a lower enclosure portion configured to be snapped to the upper enclosure portion to form an inner area; an antenna aperture having a plurality of antenna elements, the plurality of antenna elements to radiate radio-frequency (RF) energy and the antenna aperture to generate heat when in operation, wherein the upper enclosure, lower enclosure and the antenna aperture are aligned in a Z direction of an X,Y,Z axis; and an RF choke gasket forming a seal between, and being in thermal contact, with the upper and lower enclosures to operate as an RF absorber and to transfer the heat in the Z direction toward the upper enclosure.

Example 19 is the antenna apparatus of example 18 that may optionally include that the RF choke gasket comprises an anisotropic material having carbon fibers.

Example 20 is the antenna apparatus of example 18 that may optionally include that the antenna aperture includes an outer edge, and the RF choke gasket is located adjacent the outer edge and a periphery of the antenna aperture, and configured to suppress RF energy in one or more frequency bands.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1. An antenna apparatus comprising:
an upper enclosure portion;
a lower enclosure portion coupled to the upper enclosure portion to form an inner area;
an antenna aperture having a plurality of antenna elements, the plurality of antenna elements to radiate radio-frequency (RF) energy and the antenna aperture to generate heat when in operation; and
an RF choke gasket between, and forming a thermal communication, with the upper and lower enclosures to operate as an RF absorber to absorb RF energy and to directionally transfer the heat toward the upper enclosure.

2. The antenna apparatus of claim 1 wherein the upper enclosure comprises a radome and the lower enclosure comprises a backshell, wherein the RF choke gasket to directionally transfer the heat towards the radome.

3. The antenna apparatus of claim 2 wherein the upper enclosure, lower enclosure and the antenna aperture are aligned in a Z direction of an X,Y,Z axis and the RF choke gasket is operable to directionally transfer heat in the Z direction.

4. The antenna apparatus of claim 1 wherein the RF choke gasket comprises an anisotropic material.

5. The antenna apparatus of claim 1 wherein the RF choke gasket comprises a compound material having carbon fibers.

6. The antenna apparatus of claim 1 wherein the antenna aperture includes an outer edge, and the RF choke gasket is located adjacent the outer edge and a periphery of the antenna aperture, and configured to suppress RF energy in one or more frequency bands.

7. The antenna apparatus of claim 6 wherein the one or more frequency bands comprise at least one of the Ku, Ka, X, Q, and V bands.

8. The antenna apparatus of claim 6 wherein the RF choke gasket comprises a ring around the antenna aperture.

9. The antenna apparatus of claim 1 wherein the upper and lower enclosures include complementary snap features configured to couple the upper and lower enclosures.

10. The antenna apparatus of claim 1 wherein the plurality of antenna elements comprise a plurality of metamaterial antenna elements, each metamaterial antenna element of the plurality of metamaterial antenna elements having a tunable element.

11. The antenna apparatus of claim 10 wherein the tunable element comprises a varactor diode.

12. An antenna apparatus comprising:
a radome;
a lower enclosure portion coupled to the upper enclosure portion to form an inner area;
an antenna aperture having a plurality of antenna elements, the plurality of antenna elements to radiate radio-frequency (RF) energy and the antenna aperture to generate heat when in operation, wherein the radome, lower enclosure and the antenna aperture are aligned in a Z direction of an X,Y,Z axis and the RF choke gasket is operable to transfer heat in the Z direction; and
an RF choke gasket forming a seal between, and being in thermal communication with, the upper and lower enclosures to operate as an RF absorber and to transfer the heat in the Z direction toward the radome, wherein the RF choke is located adjacent an outer edge at a periphery of the antenna aperture to suppress RF energy in one or more frequency bands.

13. The antenna apparatus of claim 12 wherein the RF choke gasket comprises an anisotropic material.

14. The antenna apparatus of claim 12 wherein the RF choke gasket comprises a compound material having carbon fibers.

15. The antenna apparatus of claim 12 wherein the one or more frequency bands comprise at least one of Ku, Ka, X, Q, and V bands.

16. The antenna apparatus of claim 12 wherein the RF choke gasket comprises a ring around the antenna aperture.

17. The antenna apparatus of claim 12 wherein the upper and lower enclosures include complementary snap features configured to couple the upper and lower enclosures.

18. An antenna apparatus comprising:
an upper enclosure portion;
a lower enclosure portion configured to be snapped to the upper enclosure portion to form an inner area;
an antenna aperture having a plurality of antenna elements, the plurality of antenna elements to radiate radio-frequency (RF) energy and the antenna aperture to generate heat when in operation, wherein the upper enclosure, lower enclosure and the antenna aperture are aligned in a Z direction of an X,Y,Z axis; and
an RF choke gasket forming a seal between, and being in thermal contact, with the upper and lower enclosures to operate as an RF absorber and to transfer the heat in the Z direction toward the upper enclosure.

19. The antenna apparatus of claim 18 wherein the RF choke gasket comprises an anisotropic material having carbon fibers.

20. The antenna apparatus of claim 18 wherein the antenna aperture includes an outer edge, and the RF choke gasket is located adjacent the outer edge and a periphery of the antenna aperture, and configured to suppress RF energy in one or more frequency bands.
